(19) United States
(12) Patent Application Publication
(10) Pub. No.: US 2024/0354631 A1
(43) Pub. Date: Oct. 24, 2024

(54) Decision Tree Algorithms in Machine Learning to Learn and to Predict Innovations

(71) Applicant: Johnson Marguerite, Bloomfield Hills, MI (US)

(72) Inventor: Johnson Marguerite, Bloomfield Hills, MI (US)

(21) Appl. No.: 17/803,451

(22) PCT Filed: Jul. 19, 2022
(86) PCT No.: PCT/US22/00013

§ 371 Date: Jul. 19, 2022

(51) Int. Cl. G06N 20/00; G06N 5/022

(52) U.S. Cl. CPC G06N 20/00; G06N 5/022

(57) ABSTRACT

Decision Tree Algorithms that learn by training on datasets and models of innovations with Target Variables, Proximal Variables, Nodes, and Parameters to create predictive models.

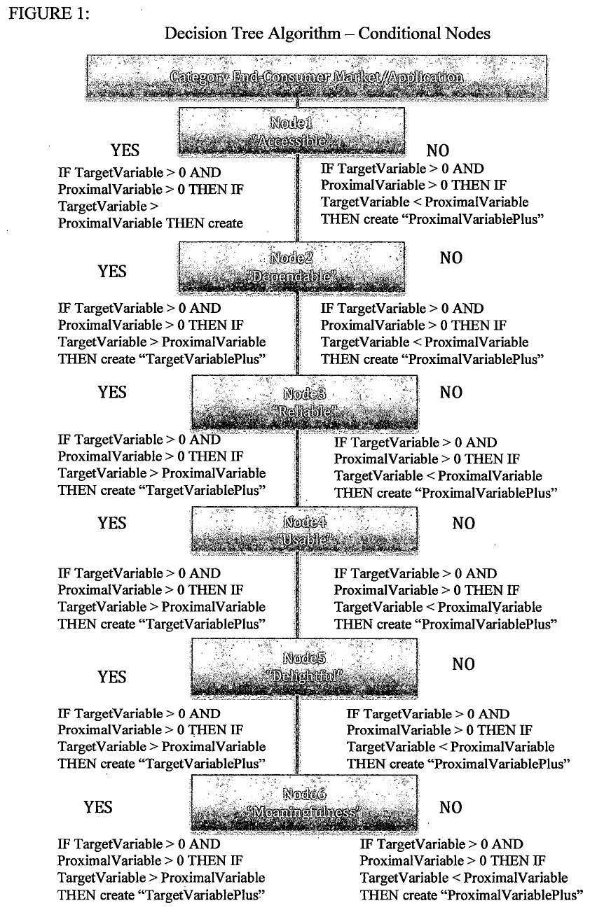

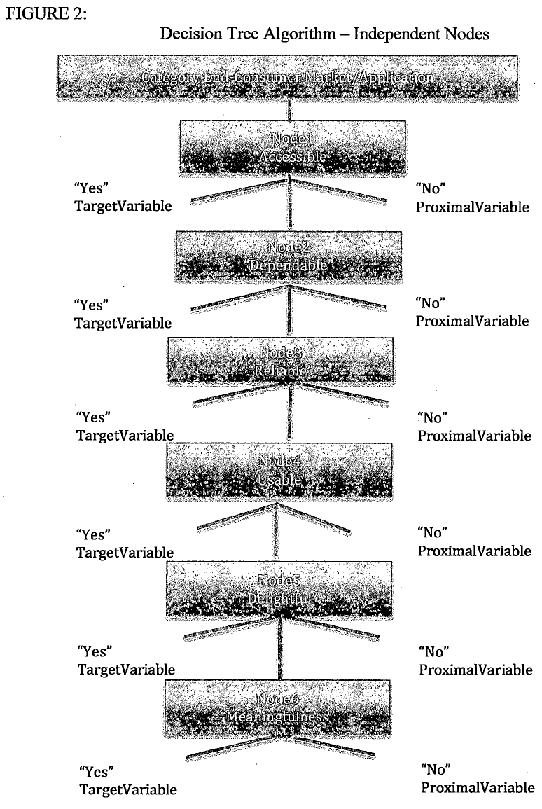

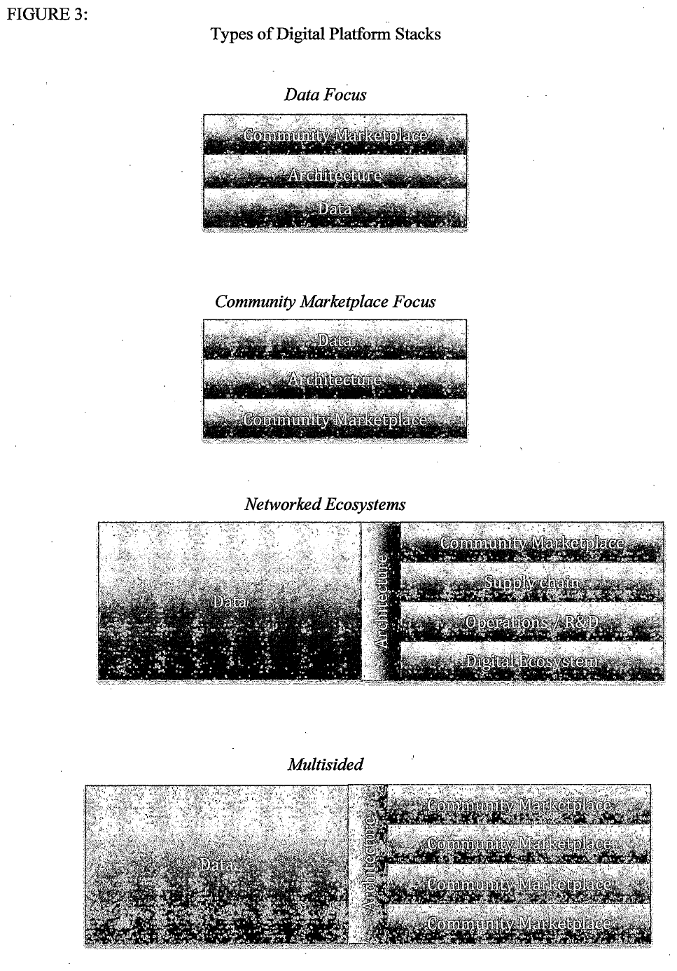

Decision Tree Algorithms can be configured to train on datasets and models of information describing, classifying, and categorizing innovations. Potentially, Decision Tree Algorithms unlock innovations hidden within historical records, specifications, reports, analyses, relationships, adjacencies, applications, products, business models, patent applications, systems, components, lab results, and other information. Subsequently, innovations can be revealed.

Furthermore, the insight and learning the Decision Tree Algorithm receives from training on datasets and models of innovations can be used to predict models, areas of focus, and whites spaces, as well as to target untapped opportunities for innovations and developments. Ultimately, Decision Tree Algorithms are configured to parse through datasets and models of innovations to accelerate growth, prioritize investments, and develop new capabilities.

In addition to predicting innovations, Decision Tree Algorithms can recommend alternatives, substitutions, modifications, trends, and other signals, using proximal attributes of innovations. Decision Tree Algorithms can reveal anomalies, outliers, and areas for further analysis and, ultimately, prevent attrition.

Innovation is a nonlinear iterative process that lacks a unifying system-a repeatable lifecycle. Because of this, innovation seems happenstance. It appears to be triggered by serendipitous moments. But it is only a lack of understanding that creates the mystery. Innovation has a repeatable lifecycle with iterative attributes-key customer expectations—that define when innovations are most likely to be viable and have an increase chance of being marketable for success. In the book, Disruptive Innovation and Digital Transformation, authored by Marguerite L. Johnson (first inventor of this PCT application), she documented observed phenomenon from her research on products, services, and business models. She identified six attributes—key customer expectations-that systematically drive innovations in a pattern: accessible, dependable, reliable, usable, delightful, and meaningfulness. Johnson labeled them as “disrupters”. They were present in innovations in the 19^{th}-century and in the 21^{st}-century, across several product offerings and business models. Johnson defined and illustrated them in a Pattern of Disruptions.

[[diagram circle and arrow images; Pattern of Disruptions Categories of Customers' Expectations; Accessible: breaks down barriers to ownership/consumption.; Dependable: quality, measured by uptime.; Reliable: infrastructure safety (assets) and digital networks (data); Copyright 2021, Marguerite Johnson; Usable: expanded utility for purposes not originally intended enabled by digital connectivity. Delightful: intense focus on user experience through a digital platform (or multisided platform).; Meaningfulness: targets Megatrends, e.g. climate change and sustainability; urbanization; aging; disparities and inequalities.]]

Furthermore, Johnson demonstrated how her Pattern of Disruptions behave inside a model, Disruptive Innovation Customers' Expectations (DICE). [[curved line; vertical lines; horizontal lines; icons; arrows; shapes; D.I.C.E. Model. Dimensions; Value Creation: ($) based on Customers' Expectations; Low; Med.; High; Favors the capabilities of incumbent's sustaining innovation having access to intimate customer knowledge to develop disruptive products and service.; Favors the disruptive capabilities of digital natives and digitally-enabled new market entrants, as digital expands the marketplace for products and services by enhancing user experience and creating network effects.; Addressable Customers' Expectations S-Curve; Source: Marguerite L. Johnson, 2021, Disruptive Innovation and Digital Transformation, Business Expert Press.; Big Bang “Shark Fin” shaped disruption; Time; Accessible; Dependable; Reliable; Tipping Point for Digital; Incumbent is disrupted; Usable; Delightful; Meaningfulness; Incumbent is disrupter]]

It is based on Johnson's observed phenomenon research on innovation attributes, defined as disrupters, that is the foundation for this PCT application on Decision-Tree Algorithms. in Machine Learning to Learn and to Predict Innovations.

Johnson designed the Decision Tree Algorithms in this PCT application to learn about the Categories, Classifications, Target and Proximal Attributes, Nodes, and Parameters of innovation datasets and models based on the Pattern of Disruptions for the purposes of predicting innovation viability.

What is claimed are:

1. Decision Tree Algorithms comprising:
Trains on innovation datasets containing Categories and Classifications that can be non-data and data types;
Target Variables defining key attributes of innovations that can be non-data and data types;
Proximal Variables are approximated attributes of Target Variables; and
Nodes that are configured to train and create predictive models.

2. Decision Tree Algorithms in claim 1, wherein Target Variables are innovations in categories.

3. Decision Tree Algorithms in claim 1, wherein Target Variables are innovations in classifications.

4. Decision Tree Algorithms in claim 1, wherein Proximal Variables are innovations in categories.

5. Decision Tree Algorithms in claim 1, wherein Proximal Variables are innovations in classifications.

6. Decision Tree Algorithms in claim 1, wherein Proximal Variables share attributes with Target Variables.

7. Decision Tree Algorithms in claim 1, wherein predictive models can be combined.

8. Decision Tree Algorithms in claim 1, wherein Nodes have defined parameters.

9. Decision Tree Algorithms in claim 1, wherein Nodes have approximated parameters.

10. Decision Tree Algorithms in claim 1, wherein Nodes are in a specific order of operation.

11. Decision Tree Algorithms in claim 1, wherein Nodes maintain specific order throughout cycles.

12. Decision Tree Algorithms in claim 1, further comprising Nodes that are configured to multiple decision tree algorithms.

13. Decision Tree Algorithms in claim 1, further comprising Nodes that are

14. Decision Tree Algorithms in claim 1, further comprising Nodes that are configured to multiple decision tree algorithms.

15. Decision Tree Algorithms in claim 1, further comprising Nodes that intersect Target Variables and Proximal Variables.

16. Decision Tree Algorithms in claim 1, further comprising Nodes that can be independent.

17. Decision Tree Algorithms in claim 1, further comprising Nodes that can be conditional.

18. Decision Tree Algorithms in claim 1, further comprising an encoder that encrypts the datasets and models.

19. Decision Tree Algorithms in claim 1, further comprising a decoder configured to decipher the encoder.

20. Decision Tree Algorithms in claim 1, further comprising reinforced learning and training on datasets.

21. Decision Tree Algorithms in claim 1, further comprising deep learning and practicing on datasets.

22. Decision Tree Algorithms in claim 1, therein perform their functionalities in a digital platform business model.

23. Decision Tree Algorithms in claim 14, further comprising a digital platform business model with multiple parties interacting.

24. Decision Tree Algorithms in claim 14, further comprising a digital platform business model with networked ecosystems of parties interacting.

25. Decision Tree Algorithms comprising:
Categories and Classifications of innovation information received through ports;
Target Variables defining key attributes of innovations that can be non-data and data types;
Proximal Variables are approximated attributes of Target Variables; and
Nodes that are configured to train and create predictive models.

26. Decision Tree Algorithms in claim 25, wherein Target Variables are innovations in categories.

27. Decision Tree Algorithms in claim 25, wherein Target Variables are innovations in classifications.

28. Decision Tree Algorithms in claim 25, wherein Proximal Variables are innovations in categories.

29. Decision Tree Algorithms in claim 25, wherein Proximal Variables are innovations in classifications.

30. Decision Tree Algorithms in claim 25, wherein Proximal Variables share attributes with Target Variables.

31. Decision Tree Algorithms in claim 25, wherein predictive models can be combined.

32. Decision Tree Algorithms in claim 25, wherein Nodes have defined parameters.

33. Decision Tree Algorithms in claim 25, wherein Nodes have approximated parameters.

34. Decision Tree Algorithms in claim 25, wherein Nodes are in a specific order of operation.

35. Decision Tree Algorithms in claim 25, wherein Nodes maintain specific order throughout cycles.

36. Decision Tree Algorithms in claim 25, further comprising Nodes that are configured to multiple decision tree algorithms.

37. Decision Tree Algorithms in claim 25, further comprising Nodes that are configured to follow a specific pattern.

38. Decision Tree Algorithms in claim 25, further comprising Nodes that are configured to multiple decision tree algorithms.

39. Decision Tree Algorithms in claim 25, further comprising Nodes that intersect Target Variables and Proximal Variables.

40. Decision Tree Algorithms in claim 25, further comprising Nodes that can be independent.

41. Decision Tree Algorithms in claim 25, further comprising Nodes that can be conditional.

42. Decision Tree Algorithms in claim 25, further comprising an encoder that encrypts the datasets and models.

43. Decision Tree Algorithms in claim 25, further comprising a decoder configured to decipher the encoder.

44. Decision Tree Algorithms in claim 25, further comprising reinforced learning and training on datasets.

45. Decision Tree Algorithms in claim 25, further comprising deep learning and practicing on datasets.

46. Decision Tree Algorithms in claim 25, therein perform their functionalities in a digital platform business model.

47. Decision Tree Algorithms in claim 36, further comprising a digital platform business model with multiple parties interacting.

48. Decision Tree Algorithms in claim 36, further comprising a digital platform business model with networked ecosystems of parties interacting.
